(19) United States
(12) Patent Application Publication
(10) Pub. No.: US 2007/0214071 A1
(43) Pub. Date: Sep. 13, 2007

(54) Methods, apparatuses and computer readable media for facilitating the creation of a forward contract for an insurance policy

(76) Inventor: Edward S. Stone, Stamford, CT (US)

Correspondence Address: ARNOLD & PORTER LLP;ATTN: IP DOCKETING DEPT., 555 TWELFTH STREET, N.W., WASHINGTON, DC, 20004-1206, US

(21) Appl. No.: 11/370,831

(22) Filed: Mar. 9, 2006

(51) Int. Cl. G06Q 40/00

(52) U.S. Cl. 705/35; 705/4

(57) ABSTRACT

The present invention relates to methods, apparatuses and computer readable media for facilitating the creation of a forward contract on an insurance policy.

### TECHNICAL FIELD

The present invention relates to methods, apparatuses and computer readable media for facilitating the creation of a forward contract for an insurance policy, which may be a life insurance policy.

### RELATED ART

There is a secondary market in which investors acquire an interest in insurance policies, and in particular life insurance policies, from existing insurance policy holders. The practice of acquiring an interest in life insurance policies from an insured individual for investment purposes is generally referred to as a viatical settlement or life settlement. The viatical settlement is typically associated with the acquisition of an interest in a life insurance policy from a life insurance policy holder suffering from a serious or terminal illness. By consummating the transaction, the policy holder receives an upfront cash payment from an investor for medical or other expenses in exchange for an interest in his or her life insurance. The method for determining the price at which a settlement may be achieved varies depending upon the needs of the investor. One such methodology is disclosed in U.S. Pat. No. 6,393,405, which is incorporated herein by reference. Upon the insured individual's death, the investor would receive payment from the insurer that issued the life insurance policy in accordance with the death benefit specified under the policy. Of course, there are many more individuals who might be amenable to transferring an interest in a life insurance policy that they hold who are not seriously or terminally ill and a growing life settlement market has emerged to facilitate their needs.

Healthy insured individuals often acquire life insurance policies based on a given set of assumptions that may change over time in a manner that obviates or reduces the need to be insured on an ongoing basis. By way of example, the major bread winner of a family may seek to acquire a death benefit that permits his or her family to maintain a certain standard of living and to pay for college expenses for children in the event of an untimely death. At some point, however, the mortgage may be paid off and the children may graduate from college such that there is no longer a need for the insured to maintain the insurance. Another example, would be a business owner who wants to ensure that there is continuity in the business that they own upon their death. If the business owner sells or otherwise disposes of their business, then there may not be a need to maintain the insurance policy going forward. Under those situations, the insured individual traditionally has had very few options. The insured individual could tender the life insurance policy to the insurance company from which it was procured for its cash surrender value, which is often very low. Alternatively, the insured individual may simply let the insurance policy lapse by not paying the appropriate premiums. Neither of those traditional options are satisfactory, given that the insured may have paid insurance premiums for years. Another approach has been to sell an interest in the insurance policy to an investor, who will receive the death benefit, or a portion thereof upon the death of the insured individual. Even this approach, however, does not afford an individual with the opportunity to anticipate ahead of time that his circumstances might change in a way that would obviate or reduce the need for life insurance, and to account for that in his or her financial planning. Therefore, what is needed is a more flexible approach to the transfer of interests in life insurance policies.

### SUMMARY OF THE INVENTION

In accordance with an exemplary embodiment of the invention, a method is provided for facilitating the creation of a forward contract for an insurance policy. The method includes the acts of providing a first entity with a put option to transfer an interest in the insurance policy to another at a predetermined future date and, in exchange, receiving consideration from the first entity. The insurance policy is issued by a second entity that is obligated to pay a benefit under the insurance policy upon an occurrence of a predetermined event, such as the death of an individual. The method may also include assigning a value for the put option that is to be used as a basis for determining the consideration to be received from the first entity, the value being a function of at least (i) a total cost of expenses associated with maintaining the put option until the predetermined future date, (ii) a total cost of expected insurance premiums to be paid subsequent to the predetermined future date, and (iii) the benefit to be paid under the insurance policy upon the occurrence of the predetermined event.

### BRIEF DESCRIPTION OF THE DRAWINGS

FIG. 1 is a block diagram showing the steps of an embodiment of the present invention.

FIG. 2 is a diagram of entities interacting in a manner to implement embodiments of the present invention.

FIG. 3 is a block diagram of an overall system that can be used to implement embodiments of the present invention.

### DETAILED DESCRIPTION OF EMBODIMENTS OF THE INVENTION

The present invention relates to methods, apparatuses and computer readable media for facilitating the creation of a forward contract for an insurance policy, and in particular a life insurance policy. The use of a forward contract to provide a put option for the acquisition of an interest in a life insurance policy should comply with all state and federal laws and regulations. For example, most states have viatical or life settlement laws that regulate the purchase and sale of life insurance in the secondary market. Essentially, entities that acquire life insurance in the secondary market in certain states need to be licensed and are subject to state insurance regulations. Therefore, it may be mandatory that an investor (or other put option provider) either be a licensed provider or, preferably, have an appropriate agreement in place with a licensed settlement provider.

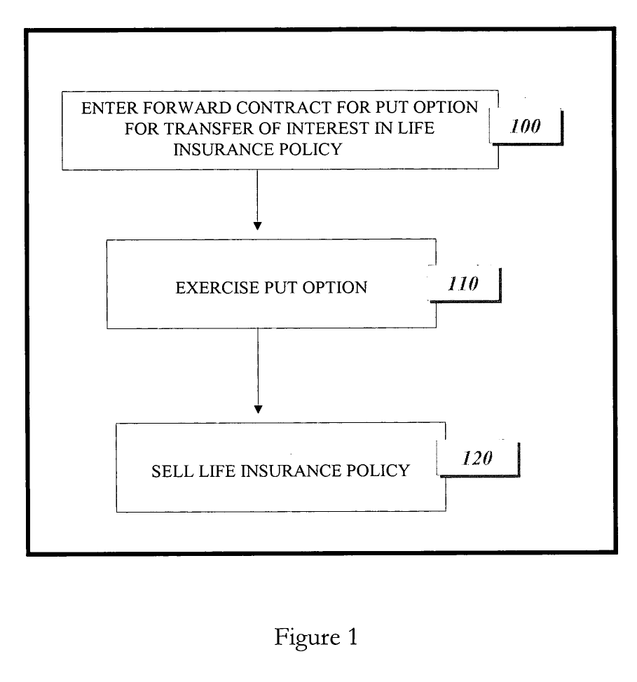

A method of an embodiment of the present invention is described with reference to FIG. 1. In a first step 100 of the method, an individual enters into a forward contract for a put option in connection with a transfer of an interest in a life insurance policy at a future date and for a price certain. The interest transferred in the life insurance policy may be the whole or something less than the whole. As a result of receiving the option, the individual obtains a put option to receive a sum certain payout, exercisable on a date certain in exchange for some consideration, such as an up-front cash payment and/or some other asset such as stocks or bonds. The individual is, in essence, buying an option on his own life. The longer the individual lives and the healthier he is, the more valuable the option is to the insured individual. In a second step 110, the individual decides to exercise the put option and delivers a put option notice to the investor or other put option provider. The put option notice includes all paperwork required to execute a life settlement agreement, including any required medical consents and continued contact agreements to ensure proper monitoring for the life of the holder of the put option after it has been exercised.

In a third step 120, the investor, who is in this instance the life settlement provider, buys the life insurance policy (in, for example, a conventional life settlement transaction) from the owner who sells the insurance policy at the pre-determined price and continues to report, track and monitor events relevant to the life insurance policy on behalf of the financing entity. If the individual lives past age ninety-five then the extension risk cover is triggered and there is a cash in-flow to the financing entity.

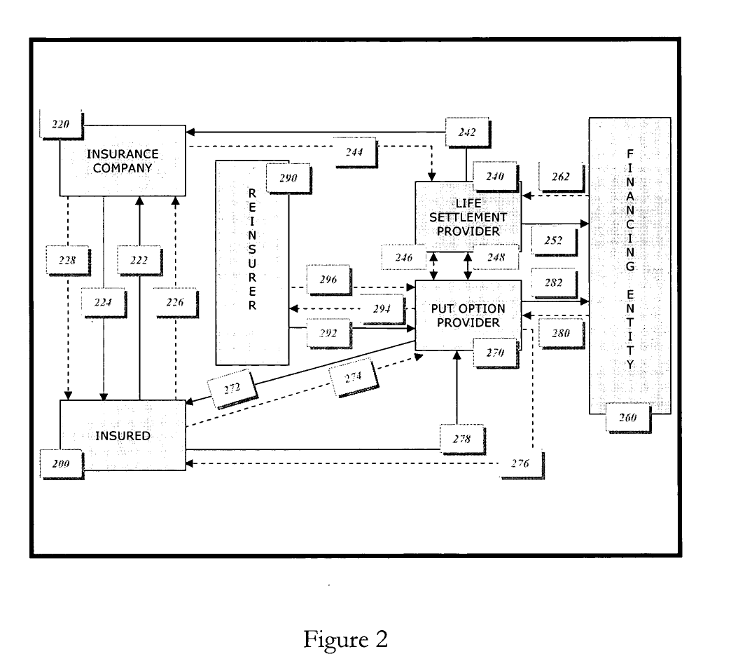

FIG. 2 shows certain entities whose activities are relevant to the implementation of the present invention. Process flows are shown in FIG. 2 as solid lines and fund flows are shown therein as dotted lines. The insured individual 200 completes the insurance application, including identifying the appropriate beneficiary, and submits 222 it to the insurance company 220. The insurance company 220 issues 224 a policy covering the life of the insured and collects 226 any premiums associated with the insurance policy. The insurance company 220 also manages policy accounts, reports to the insured (or owner of the insurance policy) on at least an annual basis. In addition, the insurance company 220 must pay 228 the cash surrender value of the insurance policy at any time upon surrender of the policy by the owner or must pay the net death benefit to the stated beneficiaries of the life insurance contract upon proof of death of the insured.

A life settlement provider 240 engages in the business of viatical or life settlements. The life settlement provider 240 negotiates with sellers or life settlement brokers and executes purchase and sale agreements (and related documents) to acquire interests in life insurance policies from the insured or owner of the policy. The life settlement provider 240 takes title to the insurance policy and reports to state insurance departments to comply with legal and regulatory obligations. Once the life settlement provider 240 takes title to the insurance policy, the life settlement provider 240 must provide 242 proof of ownership of the insurance policy upon the death of the insured individual 200 in order to receive 244 the net death benefit provided under the insurance policy. In addition, the life settlement provider 240 exchanges 246 consideration in return 248 for the right to receive the net death benefit under the insurance policy upon the death of the insured individual 200.

The life settlement provider 240 may sell 252 the insurance contract to a financing entity 260 via, for example, a U.S. based trust arrangement. The financing entity 260 provides 262 capital to the life settlement provider 240 to purchase insurance policies and as a result may get the net death benefit (or a portion thereof) upon the death of the insured individual.

A put option provider 270 (or an agent thereof) may work with the settlement provider 240 and other parties to facilitate a transaction involving a put option on the transfer of an interest in an insurance policy. The life settlement provider 240 may perform some or all of the functions of the put option provider 270. The direction of the transfer of consideration pursuant to the exchange 246 of consideration will depend upon who is financing the acquisition of the insurance policy. If the life settlement provider 240 is financing the acquisition of the life insurance policy, then the consideration will be transferred to the put option provider 270 from the life settlement provider 240 and the life settlement provider 240 will receive the net death benefit (or some portion thereof). Alternatively, if the put option provider 270 is financing the acquisition of the insurance policy, then the consideration will flow to the life settlement provider 240 from the put option provider 270 so that the life settlement provider 240 can obtain title to the insurance policy (not shown) from the insured individual 200. In that instance, the put option provider 270 will receive the net death benefit (or some portion thereof).

The put option provider 270 issues 272 a put option to the insured individual 200 (or the insurance policy owner or related trust) and receives 274 cash or some other consideration from the insured individual 200 in return. The put option provider 270 also pays 276 a sum certain to the insured individual 200 at a pre-determined date upon receipt 278 of the put option notice and related documentation. Accordingly, the put option provider 270 receives cash up front in exchange for a contingent obligation to pay a sum certain on the put option date. It is preferable to offer a put option to any holder of a life insurance contract over the age of sixty-five. It is also preferred to offer a put option to a holder who is less than the age of eighty-five.

Preferably, the put option provider 270 should be credit worthy and willing to take on a long term obligation. A preferred minimum put period is five years, with a preferred average put period being ten years. The financing entity 260 may provide 280 capital or credit enhancements to the put option provider 270 and receive 282 in exchange the right to receive either the whole or some portion of the proceeds of the net death benefit upon death of the insured individual 200 less any expenses charged by the put option provider 270.

Preferably, the put option provider 270 should acquire extension risk coverage to cover individuals that live past the age of ninety-five. This is useful because even though the probability of survival past age ninety-five is small, the premiums are expensive at that age. More importantly, the capital markets generally do not want to extend coverage for too long a period of time and eliminating the uncertainty of the post age ninety-five segment makes it easier to model cash flows. Thus, a life reinsurer, or contingency insurance provider 290 may be useful in instances where the insured individual 200 may live past age ninety-five. The life reinsurer, or contingency insurer 290 provides 292 extension risk coverage with respect to such an individual 200 in exchange for premiums paid 294 by the put option provider 270. In addition, the life reinsurer 290 may also provide 296 capital or credit enhancement to the put option provider 270. In fact, a life reinsurer 290 is a likely entity to fund a forward contract for a put option on a life insurance policy because they are used to long duration products and use actuarial forecasting extensively.

Another aspect of the present invention relates to the techniques employed to determine the price for a put option for the transfer of an interest in a life insurance policy at some date certain in the future. The price of the option may be calculated based on, for example, a sum certain payout for the insured individual 200 (or entity that owns life insurance covering the life of an individual) that is, for example, age sixty-five or older. The price of the option may also take into consideration, for example, the expected mortality of the insured individual 200, the cost to maintain the insurance contract, an assumed cost of capital and the cost of extension risk insurance. The price of the option may be indifferent to the health status of the insured individual 200, though the entity acquiring the insurance policies may well earn better returns on an insured individual 200 whose health has deteriorated since acquiring the life insurance.

Certain information relating to the insured individual 200 may be gathered to facilitate the present invention. This information may include, for example, the following information: the age of the insured individual 200, the rating at issue date, the sex of the insured individual 200, the smoker status of the insured individual 200, the type of insurance policy, the amount of the insurance policy, the premium at the issue date of the insurance policy, the expiration date of the insurance policy, the interest and crediting rates within policy, the cost of insurance tables and any applicable surrender charges. The gathered information may then be used to determine a price for the option in a manner that will factor in assumptions and determine the future value of the insurance contract in the secondary market at certain dates (i.e., put option dates). The pricing techniques used in conjunction with the present invention may assume certain conditions, including for example, that the health status of the insured individual does not deteriorate, that some percentage of the insured individuals who pay for the put option benefit will not exercise their options and that the underlying mortality will improve somewhat throughout the option period. Preferably, the pricing methodology will model the percentage of insured individuals who will not exercise the option including those who die before the put option date, those whose health or family circumstances have recently changed making the insurance more valuable to the family without the option and those who simply prefer to keep the insurance in force at the put option date for family and/or estate planning reasons.

In assessing the put option pricing, the put option provider 270 should project the future cost to maintain insurance in force from the put option date to the date of death of the insured individual, and preferably this should be accomplished by using standard mortality tables to make assumptions and build in mortality improvements (e.g., the insured individual 200 may live a year, but only pay for nine months of that year). Standard mortality tables are well-known in the art. By way of example, the Individual Life Insurance Valuation Mortality Task Force of the Society of Actuaries published the 2001 Valuation Basic Mortality Table (2001 VBT), which is well known in the art and it may be employed in connection with the present invention.

In accordance with the present invention, the price or policy holder option value (POV) at the time of offering may be determined using the following formulas:
Face=Policy Face Amount
PY=Policy Year (measured from time of issuance of insurance policy)
IA=Issue Age (age of insured at time of insurance policy)
AA=Attained Age=IA+PY−1
q_{2001VBT(AA)}=Attained Age (based on, for example, 2001 VBT Mortality)
fac=mortality adjustment factor (user assigned value assessment of mortality improvements)
q_{e(AA)}=Attained Age Expected Mortality=q_{2001VBT(IA+PY-1)}×fac
q_{w(AA)}=Insurance Policy Lapse Rate (rate is a percentage and is a user assigned value)
INF_{AA}=Percentage of Policies Inforce at Attained Age=IF_{AA-1}×(1−q_{w(AA-1)})×(1−q_{e(AA-1)})
INF_{IA}=
Opq_{w(AA)}=Option Lapse Rate (rate is a percentage and is a user assigned value)
OpINF_{AA}=Percentage of Options Inforce at Attained Age=OpIFNF_{AA-1}(1−Opq_{w(AA-1)})
OpINIF_{IA}=1
OpChg_{AA}=Attained Age Option Charge to Policyholder
OPExp_{AA}=Attained Age Option Expenses
NOpChgAA=Attained Age Net Annual Charge for Policy Option=(OpChg_{AA}−OpExp_{AA})×OpINF_{AA}
OpInt=Interest Rate to Accumulate Option Charges
AccOpChg_{AA}=(AccOpChg_{AA-1}+NOpChg_{AA})×(1+OpInt)
OED=Date when Option is to be exercised
IIF_{AA}=Percentage of Attained Age Policies In-force after Option Exercised and Investors own Policy
IIF_{AA}−IIF_{AA-1}×(1−q_{e(AA-1)})
IIF_{AA}=0 for AA<OED
IIF_{OED}=OpINF_{OED}×INF_{OED}
Prem_{AA}=Attained Age Policy Premiums (to be paid by acquirer of insurance policy after OED)
IPrem_{AA}=Investor Paid Premiums=IIF_{AA}×Prem_{AA}
DB_{AA}=Attained Age Death Benefits=q_{e(AA)}×Face×IIF_{AA}
FexP_{AA}=Attained Age Facility Expenses (to be paid by acquirer of insurance policy after OED)
IR=Investor Expected Return

$$\begin{matrix}{POV}_{ OED} = Policyholder Option Value at OED \\ = {\sum }_{t = 1}^{ OED} [ {NOpChg}_{t} \times {( 1 + OpInt )}^{OED - ( t - 1 )} ] + \\ {\sum }_{t = OED}^{∞} [ \frac{{DB}_{t} - ( {Prem}_{AA} + {Fexp}_{AA} )}{{( 1 + IR )}^{t + 1 - OED}} ]\end{matrix}$$
POV=Policyholder Option Value at Offering=POV_{OED}÷IIF_{OED}

The above-identified data and formulas facilitate calculation of the price to pay a policy holder for their insurance coverage at a future specified date. Certain assumptions underlie the use of these data and formulas, but these assumptions may vary depending on the investment priorities of the investor. One assumption is the target return rate that the investor will earn on the policy cash flows from the date that the policy holder sells his or her policy to the investor or an investment vehicle or facility owned and/or operated by the investor. Another assumption is the accumulation rate for net option premiums, which is the interest rate the investor will earn on the net proceeds (gross amount less commissions) received from policyholders who purchase the option. The net premiums are accumulated up until the option date, then those amounts are used to offset the amount paid to the policyholder who is exercising their option. This accumulation of net premiums paid is therefore factored into the target return for investors.

Additional assumptions which may also impact the above-referenced calculations, include the mortality rate, the lapse rate, the option lapse rate, the option exercise rate and the paid premium rate. With regard to the mortality rate, the higher the mortality, the fewer the number of individuals who will be living to the option date, and the higher the option value is to the policy holder. The lapse rate is that which is experienced by insurance companies. Higher lapse rates means that fewer individuals will be in a position to exercise a put option, which means that the put option will have a higher option value to the policyholder. The lapse assumption is not used once the investor takes over a policy. The option lapse rate is the rate at which policyholders lapse the option that they purchased by not paying the renewal option premiums. This assumption is a gross rate and incorporates deaths as well as voluntary lapses. Again, the higher the option lapse rate is set, then the fewer the number of individuals who will be in a position to exercise the put option and the higher the calculated option value will be to the policy holder. The option exercise rate is the percentage of eligible put option holders who actually decide to exercise their option and sell their policy instead of holding on to it. The lower the option exercise rate is set, then the fewer the number of individuals that will exercise the option and the higher the calculated option value will be to the policy holder. The paid premium rate is set at 90% of the expected mortality. A higher paid premium rate will lead to greater future costs to the investor to maintain the insurance policy, which reduces the amount that can be paid for the option. A lower paid premium rate will have just the opposite effect. The foregoing assumptions may be augmented or changed without departing from the invention.

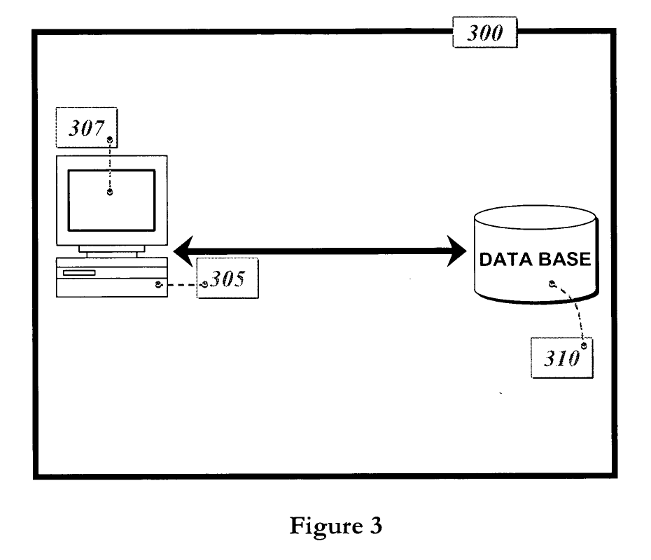

The present invention may be aided and or implemented with the use of a computer system 300, as shown in FIG. 3. The computer system 300 includes at least one computer 305 having one or more processors (not shown) coupled to memory (not shown). The computer 305 may be accessible to a user directly or indirectly via one or more networks, such as a local area network, wide area network, wireless network, or the Internet. If the computer 305 is directly accessible, the user may interact with the computer 305 via input output devices (not shown), such as a keyboard, mouse or trackball. In addition, the computer 305 may have a display 307, such as a monitor, LCD display or plasma display, which displays information to the user. The computer 305 may also be coupled to a printer (not shown) for printing information. The computer 305 stores in memory the software (and corresponding data) that is used to assist with or implement the present invention. Also stored in the memory of the computer 305 are the data relied upon by the software application of the present invention. The computer 305 may be coupled to a database 310 (or multiple databases), such as a relational database. The database 310 may store information relating to insured individual(s), insurance policies, financial data and actuarial data. By way of example, the database 310 may reside on the computer 305 or may be on a database server (not shown) that is accessible via one or more networks. Software applications may be stored on various electronic media, such as hard drives, optical drives, floppy disks, flash memory, random access memory, read only memory, or other computer readable media known in the art.

An embodiment of the present invention may be assisted or implemented with the use of a software application (or applications) contained in a computer readable medium. In particular, software is provided which facilitates the calculations of the option values already discussed using the formulas indicated above or those substantially similar to those formulas. The display 307 may be used to display the results of calculations used to implement the pricing methodology of the present invention. In a preferred embodiment, the policy holder option value calculations may be facilitated using the above referenced formulas in a spreadsheet application, such as Microsoft Excel, running on the computer 305.

Although different embodiments of the present invention have been discussed, those skilled in the art will appreciate that variations may be made thereto without departing from the principles of the present invention. Although the preferred embodiment has been described to include a number of features, an apparatus, method and computer readable medium may be designed which does not include all of those features, and yet still fall within the spirit and scope of the present invention.

What is claimed is:

1. A method for facilitating the creation of a forward contract for an insurance policy, said method comprising the acts of:
providing a first entity with a put option to transfer an interest in the insurance policy to another at a predetermined future date; and
receiving consideration from the first entity.

2. The method defined by claim 1, wherein the insurance policy is issued by a second entity that is obligated to pay a benefit under the insurance policy upon an occurrence of a predetermined event.

3. The method defined by claim 2, wherein the predetermined event is the death of an individual.

4. The method defined by claim 3, wherein the individual is at least sixty-five years of age.

5. The method defined by claim 4, wherein the individual is no more than eighty-five years of age.

6. The method defined by claim 1, wherein the consideration includes a cash payment.

7. The method defined by claim 2, further comprising the act of assigning a value for the put option that is to be used as a basis for determining the consideration to be received from the first entity, the value being a function of at least (i) a total cost of expenses associated with maintaining the put option until the predetermined future date, (ii) a total cost of expected insurance premiums to be paid subsequent to the predetermined future date, and (iii) the benefit to be paid under the insurance policy upon the occurrence of the predetermined event.

8. A method for facilitating the creation of a forward contract for an insurance policy, said method comprising the acts of:
receiving a put option to transfer an interest in the insurance policy to another at a predetermined future date; and
providing consideration in exchange for the put option.

9. The method defined by claim 8, wherein the insurance policy is issued by an entity that is obligated to pay a benefit under the insurance policy upon an occurrence of a predetermined event.

10. The method defined by claim 9, wherein the predetermined event is the death of an individual.

11. The method defined by claim 10, wherein the individual is at least sixty-five years of age.

12. The method defined by claim 11, wherein the individual is no more than eighty-five years of age.

13. The method defined by claim 8, wherein the consideration includes a cash payment.

14. The method defined by claim 9, further comprising the act of assigning a value for the put option that is to be used as a basis for determining the consideration to be received from the entity, the value being a function of at least (i) a total cost of expenses associated with maintaining the put option until the predetermined future date, (ii) a total cost of expected insurance premiums to be paid subsequent to the predetermined future date, and (iii) the benefit to be paid under the insurance policy upon the occurrence of the predetermined event.

15. A computer-readable storage medium comprising instructions to facilitate the creation of a forward contract for an insurance policy, the instructions being executable by a computer having a memory to store said instructions and to perform the following acts:
calculating a value for a put option to transfer an interest in the insurance policy to another at a predetermined future date, the value being a function of at least (i) a total cost of the expenses associated with maintaining the put option until the predetermined future date, (ii) a total cost of the expected insurance premiums to be paid subsequent to the predetermined future date, and (iii) a total benefit to be received under the insurance policy upon an occurrence of a predetermined event that triggers a right to said benefit;
storing said value in said memory;
outputting said value in a human-readable form.

16. The computer-readable storage medium defined in claim 15, wherein said predetermined event is the death of an individual.

17. An apparatus for facilitating the creation of a forward contract for an insurance policy, said apparatus comprising:
a memory storing data; and
a computer being coupled to said memory, said computer being programmed to access said memory, to retrieve a portion of the data relating to the insurance policy, to calculate a value for a put option to transfer an interest in the insurance policy to another at a predetermined future date, to store said value in said memory, and to output said value in a human-readable form;
wherein the value is a function of at least (i) a total cost of the expenses associated with maintaining the put option until the predetermined future date, (ii) a total cost of the expected insurance premiums to be paid subsequent to the predetermined future date, and (iii) a total benefit to be received under the insurance policy upon an occurrence of a predetermined event that triggers a right to the benefit.

18. The apparatus defined in claim 17, wherein said predetermined event is the death of an individual.

19. A method for facilitating the creation of a forward contract for a life insurance policy, said method comprising the acts of:
providing a first entity with a put option to transfer an interest in the life insurance policy to another at a predetermined future date, the life insurance policy being issued by a second entity that is obligated to pay a benefit under the insurance policy upon the death of an individual; and
receiving consideration from the first entity.

20. The method defined by claim 19, wherein the individual is at least sixty-five years of age.

21. The method defined by claim 20, wherein the individual is no more than eighty-five years of age.

22. The method defined by claim 19, wherein the consideration includes a cash payment.

23. The method defined by claim 19, further comprising the act of assigning a value for the put option that is to be used as a basis for determining the consideration to be received from the first entity, the value being a function of at least (i) a total cost of expenses associated with maintaining the put option until the predetermined future date, (ii) a total cost of expected insurance premiums to be paid subsequent to the predetermined future date, and (iii) the benefit to be paid under the insurance policy upon the death of the individual.

24. A method for facilitating the creation of a forward contract for a life insurance policy, said method comprising the acts of:
receiving a put option to transfer an interest in the life insurance policy to another at a predetermined future date, the insurance policy being issued by an entity that is obligated to pay a benefit under the insurance policy upon the death of an individual; and
providing consideration in exchange for the put option.

25. The method defined by claim 24, wherein the individual is at least sixty-five years of age.

26. The method defined by claim 25, wherein the individual is no more than eighty-five years of age.

27. The method defined by claim 24, wherein the consideration includes a cash payment.

28. The method defined by claim 24, further comprising the act of assigning a value for the put option that is to be used as a basis for determining the consideration to be received from the entity, the value being a function of at least (i) a total cost of expenses associated with maintaining the put option until the predetermined future date, (ii) a total cost of expected insurance premiums to be paid subsequent to the predetermined future date, and (iii) the benefit to be paid under the insurance policy upon the death of the individual.
